(19) United States
(12) Patent Application Publication
(10) Pub. No.: US 2010/0265988 A1
(43) Pub. Date: Oct. 21, 2010

(54) SUBSTRATE COOL DOWN CONTROL

(75) Inventors: JACOB NEWMAN, Palo Alto, CA (US); DINESH KANAWADE, Sunnyvale, CA (US); HENRY BARANDICA, San Jose, CA (US); NIR MERRY, Mountain View, CA (US)

Correspondence Address: MOSER IP LAW GROUP / APPLIED MATERIALS, INC., 1030 BROAD STREET, SUITE 203, SHREWSBURY, NJ, 07702, US

(73) Assignee: APPLIED MATERIALS, INC., Santa Clara, CA (US)

(21) Appl. No.: 12/758,206

(22) Filed: Apr. 12, 2010

Related U.S. Application Data
(60) Provisional application No. 61/171,128, filed on Apr. 21, 2009.

(51) Int. Cl. G01K 13/00; G01J 5/00; G01K 7/02; G01K 11/12

(52) U.S. Cl. 374/121; 374/141; 374/159; 374/179; 374/E13.001; 374/E07.004; 374/E11.018

(57) ABSTRACT

Methods and apparatus for precise substrate cool down control are provided. Apparatus for measuring temperature of substrates may include a cool down plate to support a substrate; a sensor to provide data corresponding to a temperature of the substrate when disposed on the cool down plate; and a computer coupled to the sensor to determine the temperature of the substrate from the sensor data. A method for measuring the temperature of a substrate may include providing a substrate to be cooled to a chamber having a cool down plate disposed therein, a sensor to provide data corresponding to a temperature of the substrate, and a computer coupled to the sensor; sensing a first temperature of the substrate after a predetermined first time interval has elapsed; comparing the first temperature to a predetermined temperature; and determining whether the first temperature is greater than, equal to, or less than the predetermined temperature.

### CROSS-REFERENCE TO RELATED APPLICATIONS

This application claims benefit of U.S. provisional patent application Ser. No. 61/171,128, filed Apr. 21, 2009, which is herein incorporated by reference in its entirety.

### FIELD

The present invention generally relates to substrate processing, and more particularly, to apparatus and methods for substrate cool down control.

### BACKGROUND

The fabrication of semiconductor devices upon substrates requires the deposition and etching of multiple layers of material, such as metals, dielectrics, and semiconductor materials. Throughout the fabrication process, the substrate is exposed to multiple processes, such as chemical vapor deposition, physical vapor deposition, dielectric deposition, various etching processes and the like. Each process may be performed a different operating temperature. Typically, as the substrate progresses through the various stages of processing, the substrate is moved to a number of different processing chambers, such as additional etch or deposition chambers, cool down chambers, load lock chambers, or the like. The process chambers are often part of an integrated system or cluster tool coupled to a central vacuum chamber. The central vacuum chamber usually has a transfer robot for moving the substrate from chamber to chamber.

Many substrate processes are performed at elevated temperatures (e.g. above 100 degrees Celsius). Therefore, processed substrates are often cooled in a controlled environment, such as, for example, a cool down chamber, to lower the substrate temperature to a more suitable temperature for handling or subsequent processing.

Commonly used processes for substrate cool down include placing a processed substrate in a cool down chamber for a predetermined amount of time. A typical amount of time allowed for cooling is usually greater than two minutes. However, the inventors have observed that the amount of time allowed for cooling tends to be a conservatively estimated time required for the substrate to cool down to a temperature suitable for removal of the substrate from the cool down chamber. However, the actual required substrate cooling time is often shorter than the estimated time. In addition, the inventors have also observed that the actual substrate cooling time required varies depending on many factors, for example, the composition of the substrate, the processes performed, and the like. Thus, by allowing the substrate to cool for unnecessarily long periods of time the overall process efficiency is reduced, particularly in situations such as automated and high volume processing.

Therefore, the inventors have provided improved methods and apparatus for more precise substrate cool down control.

### SUMMARY

Methods and apparatus for precise substrate cool down control are provided. In some embodiments, an apparatus for measuring the temperature of a substrate may include a cool down plate to support a substrate; a sensor to provide data corresponding to a temperature of the substrate when disposed on the cool down plate; and a computer coupled to the sensor to determine the temperature of the substrate from the sensor data.

In some embodiments, a method may be provided for measuring the temperature of a substrate to be cooled disposed in a process chamber, the process chamber having the substrate disposed on a cool down plate to cool the substrate within the process chamber and a sensor configured to provide data corresponding to a temperature of the substrate. In some embodiments, the method may include (a) sensing, with the sensor, a first temperature of the substrate after a predetermined first time interval has elapsed; (b) comparing the first temperature to a predetermined temperature; and (c) determining whether the first temperature is greater than, equal to, or less than the predetermined temperature.

In some embodiments a method to measure the temperature of a substrate may include providing a substrate having an initial temperature to a chamber, wherein the chamber comprises a cool down plate to cool the substrate thereupon, and wherein the cool down plate includes at least one sensor configured to provide data corresponding to a temperature of the substrate; sensing and recording a first temperature at a predetermined time interval; comparing the first temperature to a predetermined temperature; and determining whether the first temperature is greater than, equal to, or less than a predetermined temperature. If it is determined that the first temperature is equal to or less than the predetermined temperature then the substrate may be removed from the chamber. If it is determined that the first temperature is greater than the predetermined temperature, the temperature is continuously sensed and recorded until the sensed temperature is equal to or less than the predetermined temperature.

In some embodiments, a computer readable medium may be provided, having instructions stored thereon which, when executed by a controller, causes a process chamber to perform a method, the process chamber having a substrate to be cooled disposed on a cool down plate to cool the substrate within the process chamber and a sensor configured to provide data corresponding to a temperature of the substrate. In some embodiments, the method may include sensing, with the sensor, a first temperature of the substrate after a predetermined first time interval has elapsed; comparing the first temperature to a predetermined temperature; and determining whether the first temperature is greater than, equal to, or less than the predetermined temperature. If it is determined that the first temperature is equal to or less than the predetermined temperature, then the substrate may be removed from the chamber. If it is determined that the first temperature is greater than the predetermined temperature, the temperature is continuously sensed and recorded until the sensed temperature is equal to or less than the predetermined temperature.

Other and further embodiments and variations are disclosed herein.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only exemplary embodiments of this invention and are therefore not to be considered limiting of its scope, for the invention may admit to other equally effective embodiments.

FIG. 1 depicts an apparatus suitable for performing a substrate cool down in accordance with some embodiments of the present invention.

FIG. 2 depicts a cross sectional view of a cool down plate suitable for performing a substrate cool down in accordance with some embodiments of the present invention.

FIG. 3 depicts a bottom view of a cool down plate suitable for performing a substrate cool down in accordance with some embodiments of the present invention.

FIG. 4 depicts a method to measure the temperature of a substrate in accordance with some embodiments of the present invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to substrate processing. The inventive apparatus and methods provide for precise substrate cool down control for use in, for example, multi step substrate processing of integrated circuits. The inventive methods may advantageously provide for an accurate method of monitoring a substrate temperature as it cools, reducing the amount of time necessary to achieve the necessary substrate temperature for removal from the process chamber, and therefore, provide for a more efficient process with an improved system throughput.

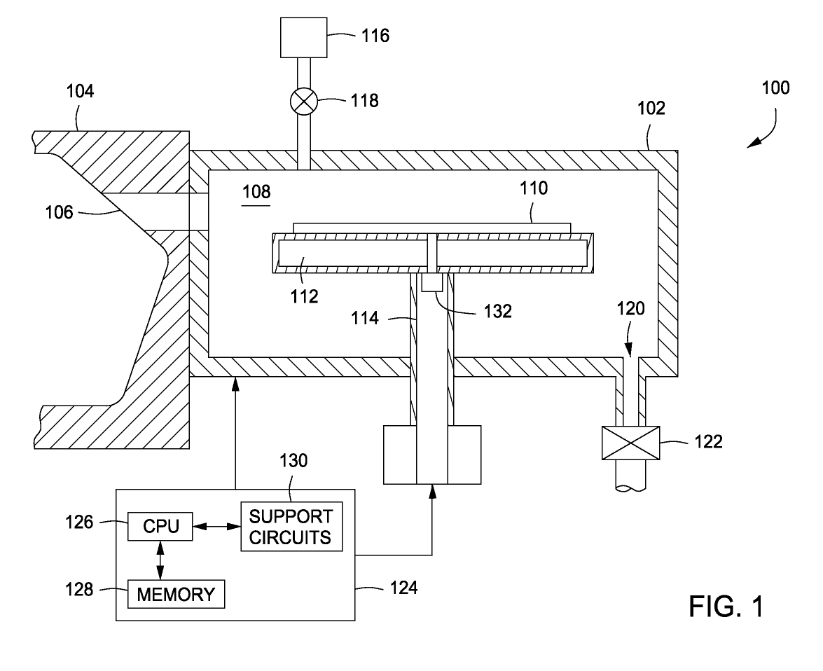

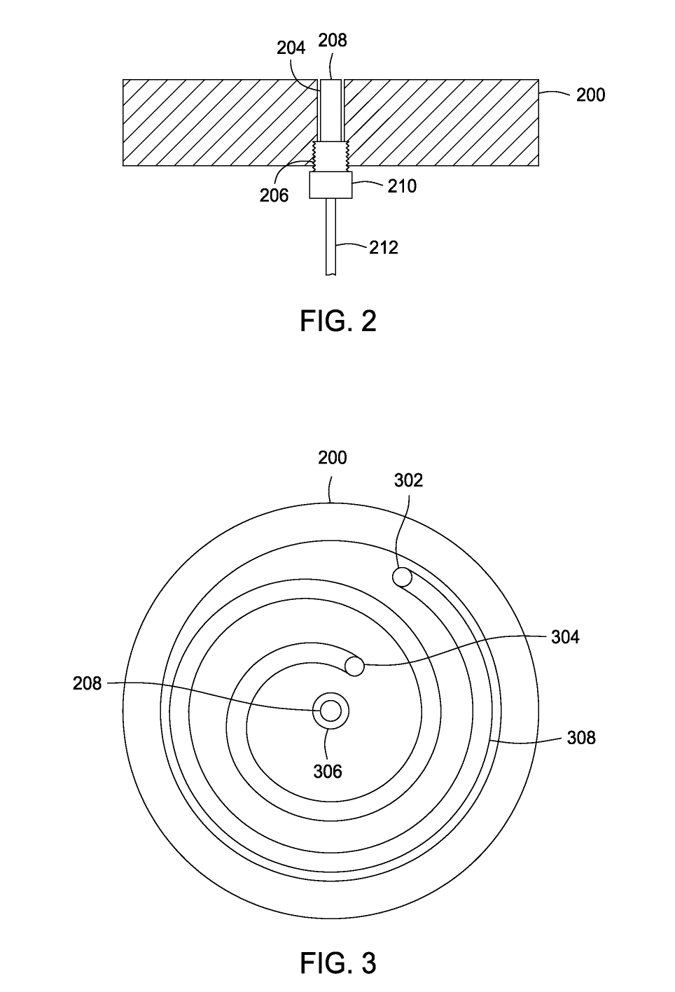

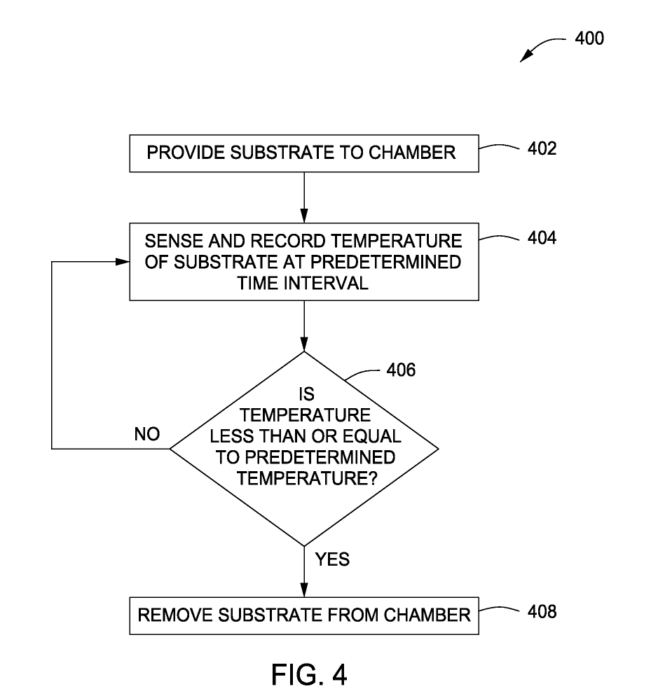

FIG. 1 depicts an apparatus suitable for performing a substrate cool down in accordance with some embodiments of the present invention. FIG. 2 depicts a cross sectional view of a cool down plate suitable for performing a substrate cool down in accordance with some embodiments of the present invention. FIG. 3 depicts a bottom view of a cool down plate suitable for performing a substrate cool down in accordance with some embodiments of the present invention. FIG. 4 depicts a method to measure the temperature of a substrate in accordance with some embodiments of the present invention.

The inventive methods described herein may be performed in a cool down chamber as described below. FIG. 1 illustrates one embodiment of a cool down chamber 100 in which the invention may be practiced. An example of an exemplary cool down chamber 100 is described in commonly assigned U.S. Pat. No. 6,602,348 filed on Sep. 17, 1996, entitled “Substrate Cooldown Chamber”, which is incorporated herein in its entirety by reference.

In some embodiments, the cool down chamber 100 may be attached to the side of buffer chamber 104 of a cluster tool (not pictured) and is in fluid communication with the buffer chamber 104 through opening 106. The opening 106 may comprise a slit valve (not pictured) for isolating the cool down chamber 100 from the buffer chamber 104. An example of a suitable cluster tool may be the CENTURA® integrated semiconductor substrate processing system, available from Applied Materials, Inc. of Santa Clara, Calif.

The cool down chamber 100 comprises an inner volume 108 for cooling defined by the chamber walls 102. Disposed within the inner volume 108 is a cooling member 112. The cooling member 112 may be of any size and shape suitable for supporting and cooling a substrate 110, such as the cool down plate 200 as described below with respect to FIGS. 2 and 3.

The substrate 110 may be any suitable substrate subject to any processing methods, such as a silicon substrate, a III-V compound substrate, a silicon germanium (SiGe) substrate, an epi-substrate, a silicon-on-insulator (SOI) substrate, a display substrate such as a liquid crystal display (LCD), a plasma display, an electro luminescence (EL) lamp display, a light emitting diode (LED) substrate, a solar cell array, solar panel, or the like. In some embodiments, the substrate 110 may be a semiconductor wafer (e.g., a 200 mm, 300 mm, or the like silicon wafer).

Coupled to the cooling member 112 is at least one sensor 132 to sense the temperature of the substrate 110 disposed atop the cooling member 112. The sensor may be any suitable sensor capable of providing data corresponding to the temperature of the substrate. For example, in some embodiments, the sensor may be an infrared (IR) sensor to measure the infrared light emitted from the substrate 110, such as the infrared sensor described with respect to FIG. 3. In some embodiments, the sensor may be a thermocouple, for example, such as the thermocouple described below with respect to FIG. 2. In some embodiments, the sensor may be a detector to detect light transmitted through the substrate 110 from a laser diode coupled to the ceiling of the chamber walls 102.

The cooling member 112 may be supported by a pedestal 114 which is vertically movable through a bellows (not shown) connected to the bottom of the chamber walls 102. One or more cooling gases may be supplied from a gas source 116 through a mass flow controller 118 into inner volume 108 of the cool down chamber 100. An exhaust port 120 may be provided and coupled to a pump (not shown) via a valve 122 for exhausting the interior of the chamber 102 and facilitating maintaining a desired pressure inside the cool down chamber 100.

A controller 124, or computer, may be coupled to various components of the cool down chamber 102. Specifically, the controller may be coupled to the sensor 132 to determine the temperature of the substrate from the data provided by the sensor 132. The controller may further record and/or analyze the substrate temperature, once determined, as discussed below. The controller may comprise a central processing unit (CPU) 126, a memory 128, and support circuits 130 for the CPU 126. The controller 124 may be one of any form of general-purpose computer processor that can be used in an industrial setting for controlling various chambers and sub-processors. The memory, or computer-readable medium, 128 of the CPU 126 may be one or more of readily available memory such as random access memory (RAM), read only memory (ROM), floppy disk, hard disk, flash, or any other form of digital storage, local or remote. The support circuits 130 are coupled to the CPU 126 for supporting the processor in a conventional manner. These circuits include cache, power supplies, clock circuits, input/output circuitry and subsystems, and the like. Inventive methods as described herein may be stored in the memory 128 as software routine that may be executed or invoked to control the operation of the cool down chamber 100 in the manner described herein. The software routine may also be stored and/or executed by a second CPU (not shown) that is remotely located from the hardware being controlled by the CPU 126.

FIG. 2 depicts a cross sectional view of a cool down plate 200 suitable for performing a substrate cool down in accordance with some embodiments of the present invention. The cool down plate 200 may comprise any suitable rigid material capable of supporting a substrate 110. In some embodiments where metal contact is permissible with the back side of the substrate 110, the cool down plate 200 may comprise a metal such as aluminum, stainless steel, or the like. In some embodiments where metal contact is impermissible, the cool down plate 200 be coated or comprise of a non metallic material, such as a ceramic. For example the non metallic material may be aluminum oxide, silicon carbide, silicon nitride, quartz, or the like. The cool down plate 200 may be cooled, for example, with a circulating coolant flowing through thermally conductive tubing, such as copper tubing, disposed proximate the substrate support surface of the cool down plate 200. In some embodiments, the surface may be planar to make flush contact with the substrate 110. Alternatively, in some embodiments, a number of pins or knobs may be formed on the surface of the cool down plate 200 to support the substrate 110 at a fixed distance above the cooling surface.

A through hole 204 may be formed in the cool down plate 200 to allow for the coupling of a sensor 208 to detect the temperature of the substrate 110. In some embodiments, more than one through hole 204 may be formed to allow for multiple sensors 208 to be coupled to the cool down plate 200 to allow for sensing the temperature at multiple points of the substrate 110. In some embodiments, such as depicted in FIG. 2, the bottom portion of the through hole 204 may be threaded to allow for a threaded coupling to be mated with the threads to hold a sensor securely in place.

The sensor may be any suitable sensor capable of providing data corresponding to the temperature of the substrate. For example, the sensor 208 may be a thermocouple, as depicted in FIG. 2. The thermocouple (sensor 208) may be secured in place using a threaded coupling 210, having threads to interface with a threaded portion 206 of the through hole 204. A connecting line 212 couples the sensor 208 to a controller (not pictured), such as the controller 124 described above with respect to FIG. 1, to determine the temperature of the substrate 110 from the data provided by the sensor 208. Once determined, the temperature of the substrate 110 may be analyzed, as discussed below.

The sensor 208 may be any suitable sensor, such as a thermocouple, capable of providing data over a desired temperature range. In some embodiments, the temperature range may range from about 20 to about 400 degrees Celsius. In some embodiments, the sensor may comprise a thermocouple having two dissimilar metals joined at one end and enclosed in a sheath, such as a metal sheath. In some embodiments, for example, such as where metal contact to the back side of the substrate 110 is undesirable the thermocouple may further comprise a non metallic material disposed atop the metal sheath. For example, the non metallic material may be a ceramic, such as silicon carbide, aluminum oxide, a ceramic composite, such as a silicon—silicon carbide composite, or the like. In some embodiments, the non conductive material may comprise a thickness of about 0.05 to about 0.125 inches.

In some embodiments, such as where contact with the backside of the substrate 110 is undesirable, the sensor 208 may be an infrared sensor. The infrared sensor may be coupled to the cool down plate 200 via any means suitable to secure the infrared sensor in place at a fixed distance from the substrate 110. For example the infrared sensor may be coupled to the body 202 via a threaded coupling, such as described above. In some embodiments, such as depicted in the bottom view of a cool down plate 212 in FIG. 3, the sensor may be coupled to a plate having a flange 306, which is then coupled to the cool down plate using a fastener, such as screws, pins, rivets, or the like. One example of a suitable infrared sensor is a thermopile infrared sensor. Suitable infrared sensors are commercially available from a variety of sources, including Micro-Epsilon America and Mikron Infrared.

FIG. 3 depicts a bottom view of a cool down plate 212 suitable for performing a substrate cool down in accordance with some embodiments of the present invention. In some embodiments, such as is in picture in FIG. 3, the cool down plate 202 may comprise a cooling fluid inlet 302 in communication with a cooling fluid source, internal cooling channels 308, and a cooling fluid outlet 304. The cooling fluid may be either a gas or liquid. In some embodiments, the cooling fluid may be chilled water. Alternatively, other coolants may be provided at the same or different temperatures. For example, antifreeze (e.g., ethylene glycol, propylene glycol, or the like) or other heat transfer fluids may be circulated through the cool down plate 200 and may be coupled to a chiller (not shown).

FIG. 4 depicts a method for the precise cooling of a substrate 110 in accordance with some embodiments of the present invention. The method begins at 402 where a substrate 110 is provided to a chamber 100 for cooling. The substrate 110 may be disposed atop a cool down plate 200 having at least one sensor 208 coupled to it, configured to provide data corresponding to a temperature of the substrate 110. The substrate 110 may be any substrate that requires cooling, such as the substrates described above with respect to FIG. 1. The chamber may be a designated cooling chamber, such as cooling chamber 100 as described above with respect to FIG. 1.

Next at 404, the temperature of the substrate is sensed by the sensor 208 at a predetermined time interval. The predetermined time interval may vary, depending on process conditions such as, the type or composition of the substrate, processes performed on the substrate, the initial temperature of the substrate, the desired final temperature of the substrate, or the like. In some embodiments, the time interval is from about 30 seconds to about 120 seconds. In some embodiments, the sensed temperature may be stored on a controller 124.

Next at 406 a query is made as to whether the sensed temperature is less than or equal to a predetermined temperature. The predetermined temperature may be dictated by a number of process conditions such as, the type or composition of the substrate, processes previously performed on the substrate, the initial temperature of the substrate, the desired final temperature of the substrate, the desired temperature of the substrate for subsequent processes, or the like.

If that query is answered in the affirmative the method moves to 408 where the substrate is removed from the chamber. The substrate 110 may be removed manually, or may be removed via an automated process, such as via a transfer robot of a cluster tool.

If the query at 406 is answered in the negative the method returns to 404, where the temperature of the substrate 110 is sensed and recorded an additional time and then proceeds again to 406.

While the foregoing is directed to embodiments of the present invention, other and further embodiments of the invention may be devised without departing from the basic scope thereof.

1. An apparatus for measuring a temperature of a substrate, comprising:
a cool down plate to support a substrate;
a sensor to provide data corresponding to a temperature of the substrate when disposed on the cool down plate; and
a computer coupled to the sensor to determine the temperature of the substrate from the sensor data.

2. The apparatus of claim 1, wherein the cool down plate is disposed in a cool down chamber.

3. The apparatus of claim 1:
wherein the cool down plate is disposed in a cool down chamber and wherein the cool down plate comprises an axial through hole; and
wherein the sensor is disposed in a position to sense a metric corresponding to a temperature of the substrate through the axial through hole.

4. The apparatus of claim 1, wherein the apparatus is configured to handle a substrate having a temperature of from about 25 to about 400 degrees Celsius.

5. The apparatus of claim 1, wherein the sensor comprises an infrared sensor to detect an infrared radiation emitted from the substrate.

6. The apparatus of claim 1, wherein the sensor comprises:
a laser diode to transmit a light through the substrate; and
a detector to detect the transmitted light.

7. The apparatus of claim 1, wherein the sensor is a thermocouple.

8. The apparatus of claim 7, wherein the thermocouple is disposed within a sheath having a non-conductive portion positioned to contact a backside of the substrate when the substrate is disposed on the cool down plate.

9. The apparatus of claim 8, wherein the non conductive material comprises at least one of silicon (Si) or silicon carbide (SiC).

10. A method for measuring the temperature of a substrate to be cooled disposed in a process chamber, the process chamber having the substrate disposed on a cool down plate to cool the substrate within the process chamber and a sensor configured to provide data corresponding to a temperature of the substrate, the method comprising:
(a) sensing, with the sensor, a first temperature of the substrate after a predetermined first time interval has elapsed;
(b) comparing the first temperature to a predetermined temperature; and
(c) determining whether the first temperature is greater than, equal to, or less than the predetermined temperature.

11. The method of claim 10, further comprising:
(e) removing the substrate from the chamber upon a determination that the first temperature is equal to or less than the predetermined temperature.

12. The method of claim 10, further comprising:
(e) determining that the first temperature is greater than the predetermined temperature;
(f) sensing a second temperature after a predetermined second time interval;
(g) comparing the second temperature to the predetermined temperature; and
(h) determining whether the second temperature is greater than, equal to, or less than the predetermined temperature.

13. The method of claim 10, wherein the chamber is a cool down chamber.

14. The method of claim 10, wherein the sensor comprises an infrared sensor, and wherein sensing the first temperature comprises:
detecting an infrared radiation emitted from the substrate using the sensor.

15. The method of claim 10, wherein the sensor comprises a laser diode and a detector, and wherein sensing the first temperature comprises:
transmitting light through the substrate using the laser diode; and
detecting the transmitted light with the detector.

16. The method of claim 10, wherein the sensor is a thermocouple.

17. The method of claim 16, wherein the thermocouple is disposed within a sheath having a non-conductive portion positioned to contact a backside of the substrate when the substrate is disposed on the cool down plate.

18. A computer readable medium, having instructions stored thereon which, when executed by a controller, causes a process chamber to perform a method, the process chamber having a substrate to be cooled disposed on a cool down plate to cool the substrate within the process chamber and a sensor configured to provide data corresponding to a temperature of the substrate, the method comprising:
(a) sensing, with the sensor, a first temperature of the substrate after a predetermined first time interval has elapsed;
(b) comparing the first temperature to a predetermined temperature; and
(c) determining whether the first temperature is greater than, equal to, or less than the predetermined temperature.

19. The computer readable medium of claim 18, further comprising:
(d) removing the substrate from the chamber upon a determination that the first temperature is equal to or less than the predetermined temperature.

20. The computer readable medium of claim 18, further comprising:
(d) determining that the first temperature is greater than the predetermined temperature;
(e) sensing a second temperature after a predetermined second time interval;
(f) comparing the second temperature to the predetermined temperature; and
(g) determining whether the second temperature is greater than, equal to, or less than the predetermined temperature.
